(19) United States
(12) Patent Application Publication
(10) Pub. No.: US 2012/0055399 A1
(43) Pub. Date: Mar. 8, 2012

(54) Paint cart with rotating part support

(75) Inventor: Karl Poehlmann, Mount Dora, FL (US)

(73) Assignee: Magna International Inc., Aurora (CA)

(21) Appl. No.: 12/807,512

(22) Filed: Sep. 7, 2010

(51) Int. Cl. B05C 13/00

(52) U.S. Cl. 118/500; 224/282

(57) ABSTRACT

A paint cart for transporting at least one component, the paint cart has a frame assembly, and at least one support extending upward from the frame assembly; the support is operable for supporting the component. The paint cart also includes a rotary device mounted to the frame assembly, the rotary device is operable for rotating the support and the component as the paint cart moves along a cart path. The paint cart moves through a paint booth located on the cart path, and there is a paint applicator inside the paint booth used for applying primer or paint to the component mounted to the support. The rotary device rotates the component as the paint cart moves along the cart path through the paint booth.

### FIELD OF THE INVENTION

The present invention relates to a paint cart used in a manufacturing facility which facilitates the rotation of a part or component being painted while the cart moves along a paint line.

### BACKGROUND OF THE INVENTION

Paint carts or paint wagons are commonly used during the assembly process of a vehicle, or other object, to transport various components along a paint line. Typically the components transported by the paint cart are all the same part, such as a fender or door panel that are to be painted the same color. As the components are transported to various stations along the line, the components are painted using various paint devices. Many of these stations have a paint device connected to and controlled by a mechanism which repositions the paint device to ensure that the entire surface of each component is painted as desired. However, in most manufacturing facilities, it is considered desirable to place as many individual components on the paint cart as possible so as to increase the overall efficiency of the paint line. The number of components that may be placed on the cart is limited because the paint device needs to be able to access all of the surfaces of each component to ensure that the component is painted properly, and if the components placed on the paint cart are too close together, then it may become difficult for the paint device to properly paint each component. Furthermore, the paint carts must be able to move through the paint line with relative ease, and if a paint cart is too big and bulky, it may reduce the efficiency of the paint line as a whole.

Accordingly, there exists a need for a paint cart which has the ability to be used for transport various components along a paint line, while at the same time also facilitating the painting of each individual component. More specifically, there exists a need for moving the components to a certain position at certain times as the paint cart moves along the cart path.

### SUMMARY OF THE INVENTION

The present invention is directed to a paint cart having a rotating part support. The part support rotates an individual part or component as the paint cart moves along a paint line or cart path.

More specifically, the present invention is directed to a paint cart for transporting at least one component, the paint cart has a frame assembly and at least one support extending upward from the frame assembly; the support is operable for supporting the component. The paint cart also includes a rotary device mounted to the frame assembly, the rotary device is operable for rotating the support and the component as the paint cart moves along a cart path.

The rotary device has a pinion gear, a lower shaft connected to and extending away from the frame assembly below the cart path. The pinion gear is mounted on the lower shaft, and the lower shaft is operable for transferring rotational force to the support. At least one rack is located underneath the cart path such that as the paint cart moves along the cart path, the pinion gear selectively engages and is in mesh with the rack, causing the pinion gear, the lower shaft, and the support to rotate, which causes the component mounted on the support to rotate.

The rotary device used for supporting the component also includes a first bevel gear connected to the support, a second bevel gear in mesh with the first bevel gear, where the second bevel gear is mounted on a first shaft. A first chain gear is also mounted on the first shaft, and the first chain gear is in mesh with a chain. The chain is also in mesh with a second chain gear, and the second chain gear is mounted on a second shaft. A third bevel gear is also mounted on the second shaft and is in mesh with a fourth bevel gear mounted on the lower shaft. As the cart moves, the pinion gear is driven for rotation by the rack, and the pinion gear transfers rotational force to the lower shaft such that rotational force is transferred from the lower shaft to the fourth bevel gear, causing the fourth bevel gear to rotate, which in turn rotates the third bevel gear, second shaft, and the second chain gear, causing the chain to transfer the rotational force to linear force, rotating the first chain gear, the first shaft, the second bevel gear, the first bevel gear, and the support, thereby rotating the component mounted to the support.

In one embodiment of the invention, the paint cart moves through a paint booth located on the cart path, and there is a paint applicator inside the paint booth used for applying primer or paint to the component mounted to the support. The rotary device rotates the component as the paint cart moves along the cart path through the paint booth.

In another embodiment, there is a plurality of paint booths and a plurality of paint applicators such that each of the plurality of paint booths has one of the plurality of paint applicators. Each of the plurality of paint applicators is operable for applying at least one coat of paint to the at least one component.

In a further embodiment of the invention, one of the paint booths is a primer booth, another of the paint booths is a base coat booth, and yet another of the paint booths is a clear coat booth.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a paint cart having a rotating part support, according to the present invention;

FIG. 2 is a perspective view of a paint cart having a rotating part support, according to the present invention;

FIG. 3 is a perspective view of a paint cart having a rotating part support located on a cart path, according to the present invention;

FIG. 4 is a perspective view of a rotating part support used with a paint cart, according to the present invention; and

FIG. 5 is a perspective view of a paint cart having a rotating part support located on a cart path having more than one paint booth, according to the present invention.

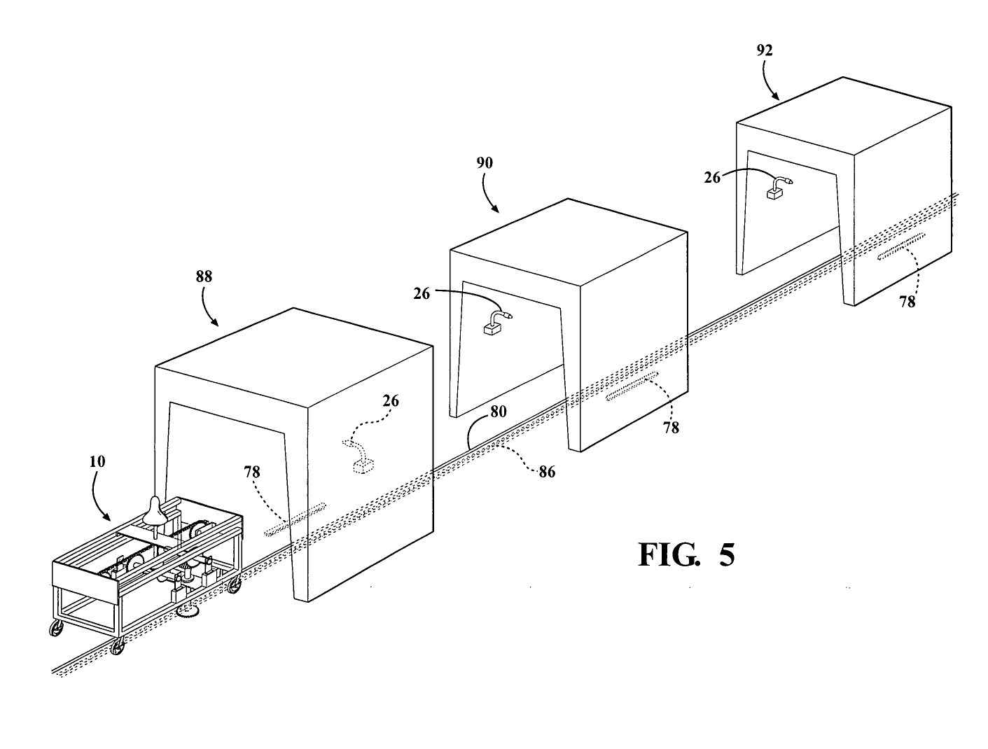

### DETAILED DESCRIPTION OF THE PREFERRED EMBODIMENTS

The following description of the preferred embodiment(s) is merely exemplary in nature and is in no way intended to limit the invention, its application, or uses.

An embodiment of a paint cart having a rotating part support according to the present invention is shown in the Figures generally at 10. The paint cart 10 includes a frame assembly, generally shown at 12, along with a plurality of leg portions 14. Each leg portion 14 is supported by a wheel 16, and the leg portions 14 and wheels 16 provide support for the cart 10 as the cart 10 moves along a cart path 18.

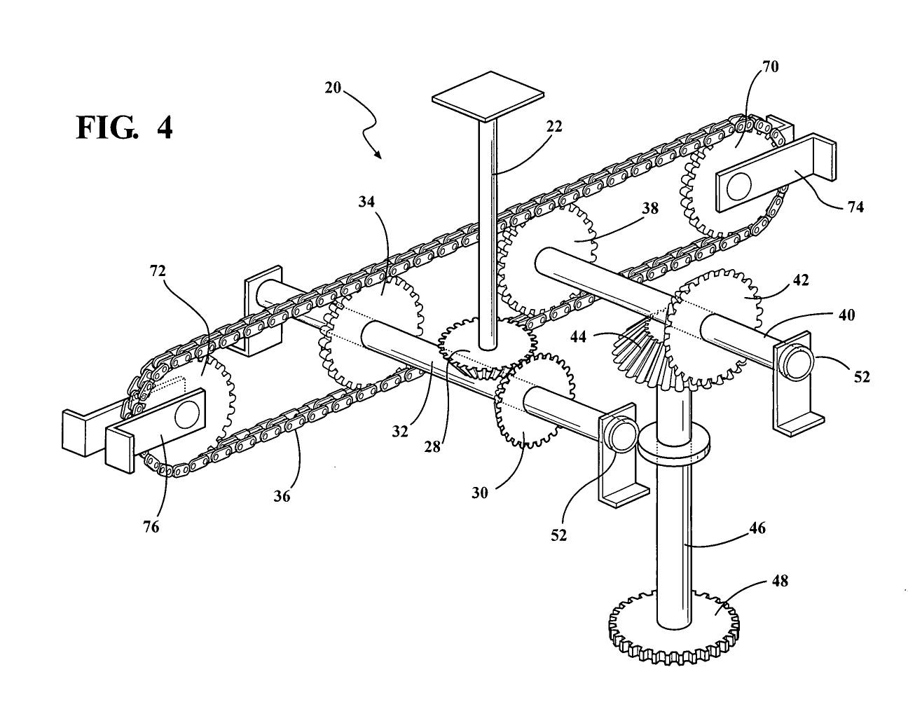

The cart 10 also includes a rotary device or rotating part support, generally shown at 20. The rotary device 20 includes a support 22 operable for supporting an individual component 24 that is to be painted by a paint applicator 26. The support 22 is connected to a first gear member or first bevel gear 28, and the first gear member 28 is in mesh with a second gear member or second bevel gear 30. The second gear member 30 is mounted on a first shaft 32, and the first shaft 32 is connected to a first chain gear 34. The first chain gear 34 is in mesh with a force transfer device, which in this embodiment is a chain 36. The chain 36 is also in mesh with a second chain gear 38, such that the chain 36 is driven by the second chain gear 38, and drives the first chain gear 34. The second chain gear 38 is connected to a second shaft 40, and the shaft 40 is connected to a third gear member, or third bevel gear 42. The third gear member 42 is in mesh with a fourth gear member or fourth bevel gear 44. The fourth bevel gear 44 is mounted on a first end or upper end of a lower shaft 46, and a pinion gear 48 is mounted on a second end or lower end of the lower shaft 46, best seen in FIG. 4.

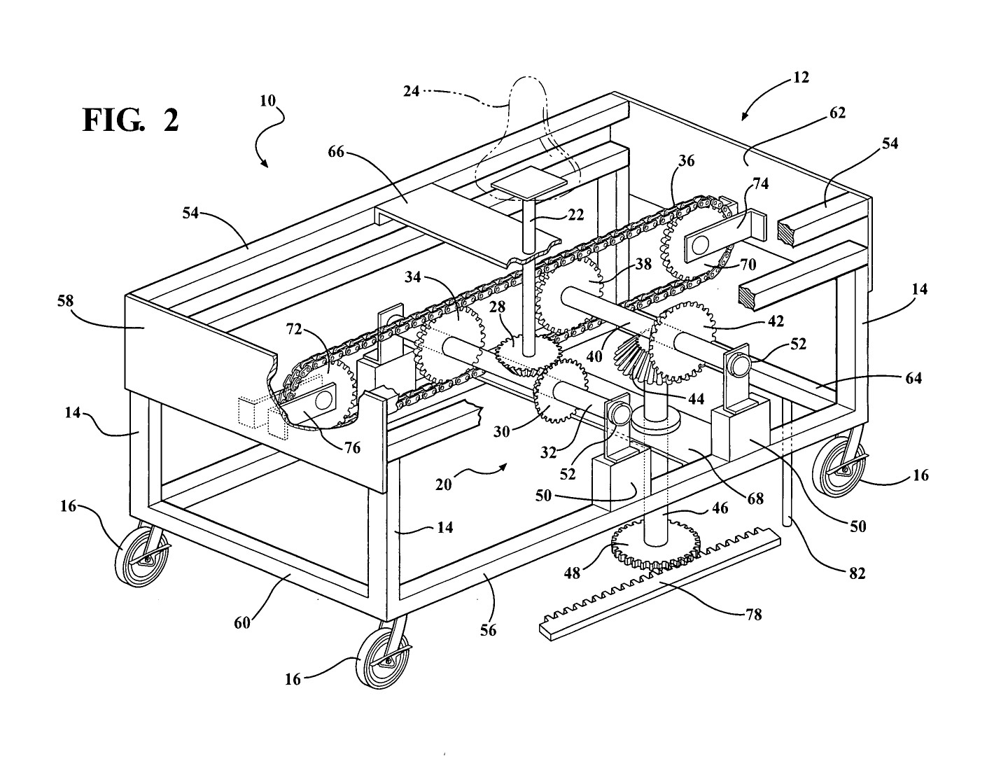

Each shaft 32,40 extends outwardly and is connected to a pair of side mounts 50 connected to the frame assembly 12, and are able to rotate relative to the side mounts 50 through the use of bearings 52. The cart 10 also includes upper frame members 54 and lower frame members 56 which are each connected to the leg portions 14, as shown in FIG. 2, and the side mounts 50 are also connected to the lower frame members 56.

Also attached to the leg portions 14 is an upper rear frame member 58 and a lower rear frame member 60, as well as an upper front frame member 62 and a lower front frame member 64. An upper beam member 66 is connected to and supported by the upper frame members 54. The support 22 extends through, is able to rotate relative to, and is supported by the beam member 66. Relative rotation between the support 22 and the beam member 66 is provided by a bearing, a bushing, or the like.

A lower beam member 68 is connected to the lower frame members 56. The lower shaft 46 extends through, is able to rotate relative to, and is supported by the beam member 68. Similarly to the support 22 and the beam member 66 above, relative rotation between the lower shaft 46 and the beam member 68 is provided by a bearing, a bushing, or the like.

The chain 36 is also supported by a first end gear 70 and a second end gear 72. The first end gear 70 is rotatably mounted on a front support 74, and the front support 74 is connected to the upper front frame member 62 as shown in FIG. 2. The second end gear 72 is rotatably mounted on a rear support 76, and the rear support 76 is connected to the upper rear frame member 58, as shown in FIG. 2.

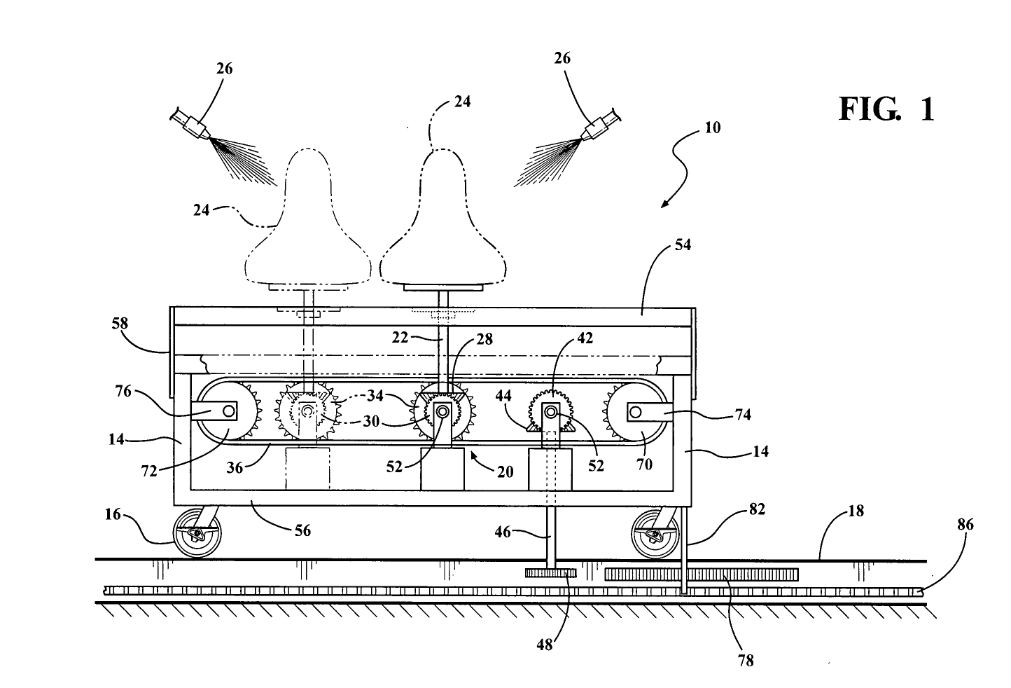

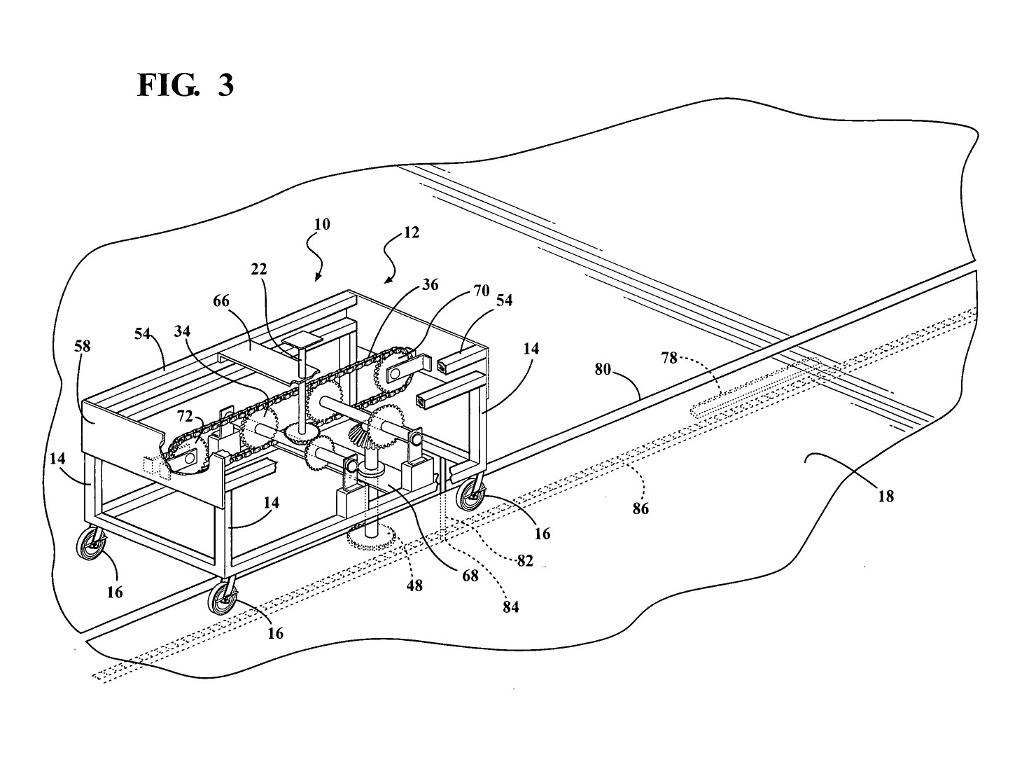

As mentioned above, the pinion gear 48 mounted on an end of the lower shaft 46. The pinion gear 48 selectively engages a rack 78 located underneath the cart path 18. The rack 78 in this embodiment is in the range of about five and seven feet long, however, it is within the scope of the invention that the rack 78 may be of other lengths as well. In addition, multiple racks may be used with the paint cart 10 at different stations, the function of which is described below. The cart path 18 in this embodiment is a floor in a building suitable for painting components, such as a manufacturing facility. The cart path 18 also includes a slot 80, and the lower shaft 46 extends down through the slot 80 such that the pinion gear 48 is disposed beneath the cart path 18, best shown in FIGS. 1 and 3.

Connected to the lower front frame member 64 is a drop pin 82, the drop pin 82 extends through the slot 80, and is long enough such that the drop pin 82 extends down further beneath the cart 10 compared to the lower shaft 46 and the pinion gear 48. The drop pin 82 engages a socket 84 which is connected to a conveyor chain 86. The conveyor chain 86 is connected to a machine (not shown) used for pulling the cart 10 through various stations for painting the component 24.

In operation, the cart 10 is moved along the cart path 18 by the conveyor chain 86 pulling the drop pin 82. While a conveyor chain 86 is used in the present embodiment, it is within the scope of the invention that the conveyor chain 86 may be replaced with a belt, a rope, or any other type of device suitable for pushing or pulling the cart 10 along the cart path 18.

As the cart 10 is moved along the path 18, when the cart 10 enters an area used for painting the component 24, which in this embodiment is a paint station or paint booth, the pinion gear 48 engages the rack 78, and the movement along the rack 78 causes the pinion gear 48 to rotate, causing rotational force to be transferred to the lower shaft 46 and then to the fourth gear member 44. The rotational force from the fourth gear member 44 is transferred to the third gear member 42, and is therefore transferred to the second shaft 40 and the second chain gear 38. As the second chain gear 38 rotates, the rotational force from the second chain gear 38 is transferred to linear force by the chain 36, and the linear force from the chain 36 is transferred to and converted to rotational force by the first chain gear 34, where the rotational force from the first chain gear 34 is transferred to the first shaft 32. The rotational force from the first shaft 32 is then transferred to the second gear member 30 and the first gear member 28 as well. Rotation of the first gear member 28 causes the support 22 to rotate, and therefore the component 24 also rotates.

Therefore, as the cart 10 moves along the cart path 18, the support 22, and the component 24 mounted to the support 22, are rotated as well. The rotation of the component 24 exposes all the surfaces of the component 24 to the paint applicator 26, thereby facilitating the complete painting of the component 24. The degree of rotation of the component 24 can be varied, and is dependent upon the length of the rack 78, and the gear ratios between the various gears 28,30,34,38,42,44,48, as well as the chain 36.

As mentioned above, the conveyor chain 86 is used to pull the cart 10 through various stations for painting the component 24. Referring to FIG. 4, the cart 10 is shown going through several paint booths, each positioned at a specific location along the cart path 18, and each paint booth also has an applicator 26. In this embodiment, there is a primer booth, shown generally at 88, a base coat booth, shown generally at 90, and a clear coat booth 92. It can be seen that the applicator 26 in the primer booth 88 is arranged on a different side of the slot 80 when compared to the applicators 26 located in the base coat booth 90 and the clear coat booth 92. However, it is within the scope of the invention that the paint applicators 26 may be arranged on either side of the slot 80 as desired, and more or less applicators may be used in each booth 88,90,92.

A rack 78 is also located underneath the cart path 18 in each of the booths 88,90,92, and each rack 78 is used for rotating the pinion gear 48 in the manner as described above such that the paint applicators 26 apply the desired amount of primer or paint to the component 24.

When moving through one of the booths 88,90,92, the component 24 may be placed on the support 22 and the cart 10 moved along the cart path 18 such that specific surfaces of the component 24 are exposed to the paint applicator 26, allowing for a specific surface of the component 24 to be painted at a specific point during the movement of the cart 10 through one of the booths 88,90,92. Furthermore, several paint applicators 26 may be positioned in each of the booths 88,90,92 along the cart path 18 to paint the various surfaces of the component 24 as the component 24 is rotated by the support 22.

In an alternate embodiment, multiple gear members may be placed in mesh with the chain 36, similar to the chain gears 34,38, and connected to shafts similar to the first shaft 32 for driving bevel gears similar to the bevel gears 28,30, and transfer rotational force to multiple supports, similar to the support 22. This allows for multiple components, such as more than one of component 24, to be painted by the paint applicator 26. This is best shown in phantom in FIG. 1.

In another alternate embodiment, if it is desired to only have one component per cart 10, the chain 36, the chain gears 34,38, the shafts 32,40, and the bevel gears 30,42 may be eliminated and the support 22 and first gear member 28 may be assembled to the upper beam member 66 such that the first gear member 28 is directly in mesh with the fourth gear member 44. In yet another alternate embodiment, a plurality of gears may be used to replace the chain 36, chain gears 34,38, and bevel gears 30,42 with a gear train for causing the support 22 to rotate as desired.

In another alternate embodiment of the invention, several of the gear members 30,34,38,42 may be removed. The fourth gear member 44 is shaped to be in mesh directly with the chain 36, and the first gear member 28 is also shaped so as to be directly in mesh with the chain 36. When the cart 10 moves along the cart path 18, and the pinion gear 48 is in mesh with the rack 78, the pinion gear 48 and lower shaft 46 rotate, driving the chain 36, and therefore rotating the first gear member 28 and the support 22. Additionally, as mentioned above, multiple supports 22 may be used with multiple gear members 28 in mesh with the chain 36 to rotate multiple components 24 as the paint cart 10 moves along the cart path 18.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A paint cart for transporting at least one component, comprising:
a frame assembly;
at least one support extending upward from said frame assembly, said at least one support operable for supporting said at least one component; and
a rotary device mounted to said frame assembly, said rotary device operable for rotating said support and said at least one component as said paint cart moves along a cart path.

2. The paint cart for transporting at least one component of claim 1, said rotary device further comprising:
a pinion gear;
a lower shaft connected to and extending away from said frame assembly below said cart path, said pinion gear mounted on said lower shaft, said lower shaft is operable for transferring rotational force to said at least one support; and
at least one rack located underneath said cart path such that as said cart moves along said cart path, said pinion gear selectively engages and is in mesh with said at least one rack, causing said pinion gear, said lower shaft, and said support to rotate, which causes said at least one component to rotate.

3. The paint cart for transporting at least one component of claim 2, said rotary device further comprising:
a first bevel gear connected to said support;
a second bevel gear in mesh with said first bevel gear, said second bevel gear mounted on a first shaft;
a first chain gear mounted on said first shaft;
a chain, said first chain gear in mesh with said chain;
a second chain gear, said second chain gear in mesh with said chain;
a second shaft, said second chain gear connected to said second shaft;
a third bevel gear mounted on said second shaft; and
a fourth bevel gear mounted on said lower shaft, said fourth bevel gear in mesh with said third bevel gear, and as said cart moves, said pinion gear is driven for rotation by said at least one rack, and said pinion gear transfers rotational force to said lower shaft such that rotational force is transferred from said lower shaft to said fourth bevel gear, causing said fourth bevel gear to rotate, which in turn rotates said third bevel gear, second shaft, and said second chain gear, causing said chain to transfer said rotational force to said linear force, rotating said first chain gear, said first shaft, and said second bevel gear, said first bevel gear, and said support, thereby rotating at least one component mounted to said at least one support.

4. The paint cart for transporting at least one component of claim 1, further comprising at least one paint applicator located along said cart path, said at least one paint applicator operable for applying paint to said at least one component as said at least one component is rotated by said rotary device.

5. The paint cart for transporting at least one component of claim 4, further comprising at least one paint booth located along said cart path, said at least one paint applicator disposed in said at least one paint booth, and when said paint cart moves through said at least one booth, said rotary device rotates said support and said at least one component when said paint cart is inside said at least one paint booth.

6. The paint cart for transporting at least one component of claim 5, said at least one paint booth further comprising a plurality of paint booths and said at least one paint applicator further comprising a plurality of paint applicators such that each of said plurality of paint booths have one of said plurality of paint applicators, each of said plurality of paint applicators operable for applying at least one coat of paint to said at least-one component.

7. The paint cart for transporting at least one component of claim 6, one of said plurality of paint booths further comprising a primer booth, one of said plurality of paint booths further comprising a base coat booth, and another of said plurality of paint booths further comprising a clear coat booth.

8. The paint cart for transporting at least one component of claim 1, further comprising:
at least one leg portion connected to said frame assembly; and
at least one wheel connected to said at least one leg portion, said at least one wheel operable for moving said paint cart along said cart path.

9. The paint cart for transporting at least one component of claim 1, further comprising:
a slot formed along at least a portion of said cart path;
a drop pin connected to said frame assembly; and
a conveyor chain, wherein said drop pin extends away from said frame assembly through said slot and engages said conveyor chain such that as said conveyor chain is moved, said conveyor chain pulls said drop pin, and said paint cart is pulled along said cart path.

10. A paint cart for transporting at least one component along a cart path, comprising:
a frame assembly;
at least one support member extending upward and away from said frame assembly;
a gear member attached to said at least one support member;
a lower shaft extending downwardly and away from said frame assembly;
a gear member attached to a first end of said lower shaft, operable for driving said gear member attached to said at least one support member;
a pinion gear attached a second end of said lower shaft;
at least one rack positioned along a cart path such that as said paint cart moves along said cart part, said pinion gear engages and meshes with said at least one rack, causing said pinion gear, said gear member attached to said lower shaft, and said lower shaft to rotate, thereby rotating said gear member attached to said at least one support member, and said support member; and
at least one component attached to said at least one support member, and said at least one component rotates as said at least one support member rotates.

11. The paint cart for transporting at least one component along a cart path of claim 10, further comprising:
said gear member attached to said at least one support member further comprising a first bevel gear;
a second bevel gear mounted on a first shaft, said second bevel gear in mesh with said first bevel gear;
a first chain gear mounted on said first shaft;
a chain, said first chain gear in mesh with said chain;
a second chain gear, said second chain gear in mesh with said chain;
a second shaft, said second chain gear mounted on said second shaft;
a third bevel gear mounted on said second shaft; and
said gear member attached to said first end of said lower shaft further comprising a fourth bevel gear mounted on said lower shaft, said fourth bevel gear in mesh with said third bevel gear;
wherein as said lower shaft is driven for rotation by said pinion gear and said at least one rack, said fourth bevel gear transfers rotational force to said third bevel gear, said second shaft, said second chain gear, and said chain, driving said chain and rotating said first chain gear, said first shaft, and said second bevel gear, thereby rotating said first bevel gear and said at least one support.

12. The paint cart for transporting at least one component along a cart path of claim 10, further comprising:
a slot formed as part of and extending along the length of said cart path;
a drop pin connected to said frame assembly such that said drop pin extends downwardly from said frame assembly into said slot;
a conveyor chain disposed beneath said cart path in proximity to said slot, wherein said drop pin engages said conveyor chain such that as said conveyor chain is moved, said conveyor chain pulls said drop pin and said paint cart along said cart path;
a plurality of paint booths located along said cart path, said paint cart is pulled through each of said plurality of booths as said conveyor chain pulls said drop pin along said cart path; and
a plurality of paint applicators, each one of said plurality of paint applicators located along said cart path and surrounded by one of said plurality of paint booths such that each of said plurality of paint applicators applies at least one coat of paint to said at least one component as said paint cart moves through each of said plurality of paint booths.

13. The paint cart for transporting at least one component along a cart path of claim 12, said at least one rack further comprising a plurality of racks, each of said plurality of racks disposed underneath one of said plurality of booths such that said pinion gear engages each of said plurality of racks as said paint cart moves through each of said plurality of booths.

14. The paint cart for transporting at least one component along a cart path of claim 12, one of said plurality of paint booths further comprising a primer booth, one of said plurality of paint booths further comprising a base coat booth, and another of said plurality of paint booths further comprising a clear coat booth.

15. The paint cart for transporting at least one component along a cart path of claim 10, further comprising:
at least one leg portion connected to said frame assembly; and
at least one wheel connected to said at least one leg portion, said at least one wheel operable for moving said paint cart along said cart path.

16. A paint cart having a rotary device, comprising:
a frame assembly;
at least one leg portion formed as part of said frame assembly;
at least one wheel connected to said at least one leg portion;
a support extending upward and out of said frame assembly;
a first bevel gear connected to said support;
a second bevel gear in mesh with said first bevel gear, said second bevel gear mounted on a first shaft;
a first chain gear mounted on said first shaft;
a chain, said first chain gear in mesh with said chain;
a second chain gear, said second chain gear in mesh with said chain;
a second shaft, said second chain gear connected to said second shaft;
a third bevel gear mounted on said second shaft;
a fourth bevel gear, said fourth bevel gear in mesh with said third bevel gear;
a lower shaft, said fourth bevel gear mounted on said lower shaft;
a pinion gear, said pinion gear mounted on said lower shaft; and
a rack, said pinion gear selectively in mesh with said rack such that as said cart moves, said pinion gear is driven for rotation by said rack, and said pinion gear transfers rotational force to said lower shaft such that rotational force is transferred from said lower shaft to said fourth bevel gear, causing said fourth bevel gear to rotate, which in turn rotates said third bevel gear, second shaft, and said second chain gear, causing said chain to transfer said rotational force to said linear force, rotating said first chain gear, said first shaft, and said second bevel gear, said first bevel gear, and said support, thereby rotating at least one component mounted to said support.

17. The paint cart having a rotary device of claim 16, further comprising:
a cart path, said paint cart operable for movement along said cart path;
a slot formed as part of said cart path;
a drop pin extending from said paint cart through said slot; and
a conveyor chain, said drop pin engaged with said conveyor chain such that as said conveyor chain is moved, said conveyor chain pulls said drop pin and said paint cart along said cart path.

18. The paint cart having a rotary device of claim 17, further comprising:
at least one paint booth at a location along said cart path; and
at least one paint applicator located in said paint booth, wherein said rack is located underneath said cart path at said location such that as said paint cart moves through said paint booth, said rack engages with said pinion gear, causing said component mounted to said support to rotate when said paint cart moves through said at least one paint booth, and said at least one paint applicator applies paint to said at least one component.

19. The paint cart having a rotary device of claim 18, further comprising:
said at least one paint booth further comprises a plurality of paint booths located along said cart path, each of said plurality of paint booths having at least one paint applicator operable for applying at least one coat of paint to said at least one component; and
said rack further comprises a plurality of racks, each of said plurality of racks disposed underneath one of said plurality of paint booths such that said pinion gear engages each of said plurality of racks as said paint cart moves through each of said plurality of paint booths.

20. The paint cart having a rotary device of claim 19, wherein one of said plurality of paint booths is a primer booth, one of said plurality of paint booths is a base coat booth, and another of said plurality of paint booths is a clear coat booth.
